(19) United States
(12) Patent Application Publication
(10) Pub. No.: US 2013/0102464 A1
(43) Pub. Date: Apr. 25, 2013

(54) USE OF A NATURAL EXTRACT OF GRAPE MARC FOR PROMOTING PLANT GROWTH

(71) Applicant: Adeline Bordier, Paris cedex 09 (FR)

(72) Inventor: Adeline Bordier, Paris cedex 09 (FR)

(73) Assignee: Laboratoires Goemar, Saint Malo Cedex (FR)

(21) Appl. No.: 13/807,531

(22) PCT Filed: Jul. 1, 2011
(86) PCT No.: PCT/FR2011/051546

§ 371 Date: Dec. 28, 2012

(30) Foreign Application Priority Data
Jul. 2, 2010 (FR) 1055398

(51) Int. Cl. A01N 65/03; A01N 43/16; A01N 31/08

(52) U.S. Cl. CPC A01N 65/03; A01N 31/08; A01N 43/16
USPC 504/117; 504/354; 504/292

(57) ABSTRACT

The invention relates to the use of an extract of grape marc for promoting plant growth and to a method for promoting plant growth which comprises the application of a composition comprising an extract of grape marc to said plants.

Increase in yields is a central preoccupation of farmers. Now, yield largely depends on good development of the plant and consequently on its growth, as well as its good health.

Plant growth is directly linked to the absorption and assimilation of minerals as well as the flows of hormones governing the elongation and differentiation of plant, tissues. Consequently, nutrients and hormones play an essential role in plant growth. Owing to their inability to move, plants have elaborated active and activable mechanisms enabling them to make the best possible use of the available resources to promote their growth. Fertilizers are used in order to increase said growth. It is also possible to use other molecules, often carbohydrates, extracted from algae for promoting growth. S. Ntougias et al. in 8th International conference on Environmental science and technology, 2003 pp. 666-673, and E. Erhart et al. in J. Phytopathology, Vol. 147, 1999, pp. 299-305, studied the use of composts, i.e. biodegraded vegetable waste, for promoting plant growth.

There is therefore a need for an environment-friendly composition that is safe for the plants for which it is intended, and that promotes plant growth. The present inventors have found that a natural extract of grape marc displays said activity. The extract proposed therefore has the capacity to activate the growth of plants that are treated.

Thus, the invention relates to the use of an extract of grape marc for promoting plant growth. Grape marc consists of a solid part resulting from pressing of grape seeds, i.e. skins, pips and optionally stalk. Grape marc therefore results from the physical transformation of grape seeds. The extract of grape marc has not undergone composting.

The extract of grape marc whose use is proposed gives a consistent increase in weight of the aerial and root parts of plants and a consistent increase in the chlorophyll content of plants, indicating better assimilation of the available elements. The extract of grape marc whose use is proposed therefore activates the growth of the plants that are treated.

According to one embodiment, the extract of grape marc whose use forms the object of the present invention comprises natural compounds synthesized by the grape itself, which is grown extensively, and which are obtained by a traditional (non-industrial) method. These compounds therefore have much more chance of being well tolerated and of having nontoxic effects. These natural compounds can finally be used in biological agriculture.

These natural compounds are notably polyphenols and anthocyans. The extract used according to the invention can contain more than 45 wt. %, preferably more than 70 wt % of polyphenols relative to its dry weight. The extract, can also comprise more than 0.5 wt %, preferably more than 8 wt % of anthocyans relative to the dry weight of the extract.

The extract of grape marc used according to the invention can be prepared from red marc to which water is added and centrifugation is carried out, the product from centrifugation is then submitted to extraction in a water-ethanol mixture comprising less than 30% v/v of ethanol, then it is concentrated under vacuum and sprayed without a drying substrate, so as to obtain a powder. The process is carried out in the presence of SO₂, without adding any additive. The sulfite added to the spraying water, at a level of about 1 g/l, has the role of solubilizing the anthocyans and limiting their oxidation.

The natural compounds present in the extract of grape marc are compounds that are easy to extract, inexpensive, water-soluble and therefore easy to use (easy dilution), and presentable owing to the coloration from the anthocyan pigments. They can improve the presentation of a pesticide product and the properties of the components accompanying the active substances on account of their photoprotective role.

The use according to the invention is perfectly suitable for plants selected from the group comprising agronomically useful plants and ornamental plants.

The agrononomically useful plants are angiosperms selected from the group comprising Apiaceae, Asteraceae, Brassicaceae, Chenopodiaceae, Convoivulaceae, Cucurbitaceae, Fabaeae, Liliaceae, Poiygonaceae, Rosaceae, Solanaceae, Poaoeae, Vitaceae.

The invention also relates to a method of promoting plant growth that comprises application of a composition comprising an extract of grape marc on said plants.

The composition employed in the method according to the invention comprises an aqueous-alcoholic extract of grape marc as active product. The extract of grape marc comprises more than 45 wt %, preferably more than 70 wt % of polyphenols relative to the dry weight of the extract.

The extract comprises more than 0.5 wt %, preferably more than 8 wt. % of anthocyans relative to the dry weight of the extract. The extract of grape marc is advantageously obtained according to the method described above.

The composition employed in the method according to the invention can be in powder form or in liquid form.

When the composition is in the form of powder, it is free from any other active agent.

It is also free from any nonnatural additive. According to a particular embodiment, the composition employed in the method, according to the invention comprises the extract of grape marc and water and is free from stabilizer.

According to another embodiment, the composition employed in the method intended for promoting plant growth according to the invention comprises a filtrate from algae, in combination with the extract of grape marc.

According to a particular embodiment of the method, according to the invention, the composition is an aqueous composition, that is applied by foliar spraying or by infiltration.

The concentration of extract of grape marc in the composition employed in the method according to the invention is between 0.05 g/L and 3 g/L, preferably between 0.1 g/L and 0.5 g/L, even, more preferably between 0.375 g/L and 0.4 g/L, for foliar application with a view to improving plant growth. Spraying can be carried out throughout the growth of the plant, at least once weekly, preferably two to three times weekly.

The composition is applied at a rate of 0.05 to 3.0 kg/ha, preferably from 0.5 to 2.0 kg/ha of crops to be treated.

The application doses and the application conditions depend of course on the plant species to be treated, and its stage of development.

The method according to the invention can be applied on agronomically useful plants and ornamental plants. Said plants are those mentioned above in connection with use.

Very interesting results have been demonstrated on tomato seedlings grown in a greenhouse following repeated foliar applications, in this case starting from 0.375 g/L. A significant increase was observed in growth based on weight (of dry matter) of the aerial and root parts of tomato seedlings treated with the extract relative to control seedlings (treated with ultrapure water). The contents of chlorophyll a, chlorophyll b and total chlorophylls (measured by spectrophotometry) of the seedlings treated with the extract are also significantly higher than those of the seedlings treated with water, a sign, of better assimilation of nutrients. The increase in chlorophyll contents reflects an improvement of photosynthetic activity, which is reflected, in an increase of general growth, demonstrating the capacity of the extract of grape marc for activating the growth of: the plants treated.

The use of this extract will make it possible to use smaller amounts of fertilizers, giving an increase in yields. In biological culture, the use of this extract will allow the partial or complete disappearance of manures or chemical fertilizers.

The invention will be described in more detail below based on the following examples, which are given purely for purposes of illustration.

### EXAMPLES

In the following examples, the extract of grape marc used is the product marketed by the company GRAP'SOD under the brand name exGrape® Anthocyanins. This product has the following characteristics:

slightly granulated, dark red powder

total polyphenols:
(in catechin equivalent) OD 280 nm: ≧70%
(in gallic acid equivalent) FOLIN CIOCALTEU: ≧60%

procyanidins:
(in catechin equivalent) Vanillin method; ≧5%

anthocyans:
Bisulfite bleaching: ≧8%

This product is called “EXTRACT” in the examples.

In the examples, an algal filtrate is used, from which cellulose and insoluble alginates have been removed.

### Example 1

Seeds of Durinta tomato are sown in compost, in a greenhouse. The seedlings are watered three times a week with mains water. The first spraying is carried, out at the 2-leaf stage. This is followed by 3 other sprayings at intervals of 2-3 days. In all, 4 successive sprayings are therefore carried oat on 1 seedling for each set of conditions.

The EXTRACT is used at the following 3 doses, 1 g/L, 2 g/L and 3 g/L. Water was used as control.

The seedlings are examined before each spraying in order to identify any suspicious trace that might arise from phytotoxicity.

No trace of phytotoxicity is observed for each of the dosages.

### Example 2

The test of example 1 was repeated, with only a single spraying, with the following concentrations of EXTRACT: 10 g/L, 20 g/L and 30 g/L and using a positive control, namely the algal filtrate from Ascophyllum nodosum, which promotes growth of the seedlings, at a dilution, of 100 and of 25.

No trace of toxicity was observed.

### Example 3

Seeds of Durinta tomato are sown and then transferred to perlite 15 days later. The seedlings are grown in a greenhouse throughout the experiment and their nutrition is provided by successive watering three times a week (Monday, Wednesday and Friday) with a nutrient solution at 0.2 g/L.

The treatments were started after planting out, on seedlings at the 2-3-leaf stage. The foliar applications were made 3 times a week, with milliQ purified water serving as control. In all, 14 applications were carried out on the 5 seedlings for each set of conditions.

Test conditions:
Control: water
Algal filtrate diluted 100-fold (FILTRATE dil 100)
Algal filtrate diluted 25-fold (FILTRATE dil 25)
EXTRACT 1.5 g/L
EXTRACT 3 g/L

At the end of the experiment, the aerial and root parts are taken, weighed separately (fresh matter, FM), dried for 48 h at 105° C. and weighed again separately (dry matter, DM),

Results:

1—Effect on the General Appearance of the Seedlings

The seedlings are harvested when differences in terms of size and color (chlorophyll contents) of the seedlings are clearly visible, i.e. 65 days after sowing, or after 14 applications. Any other symptom connected with the growing conditions of the seedlings is noted.

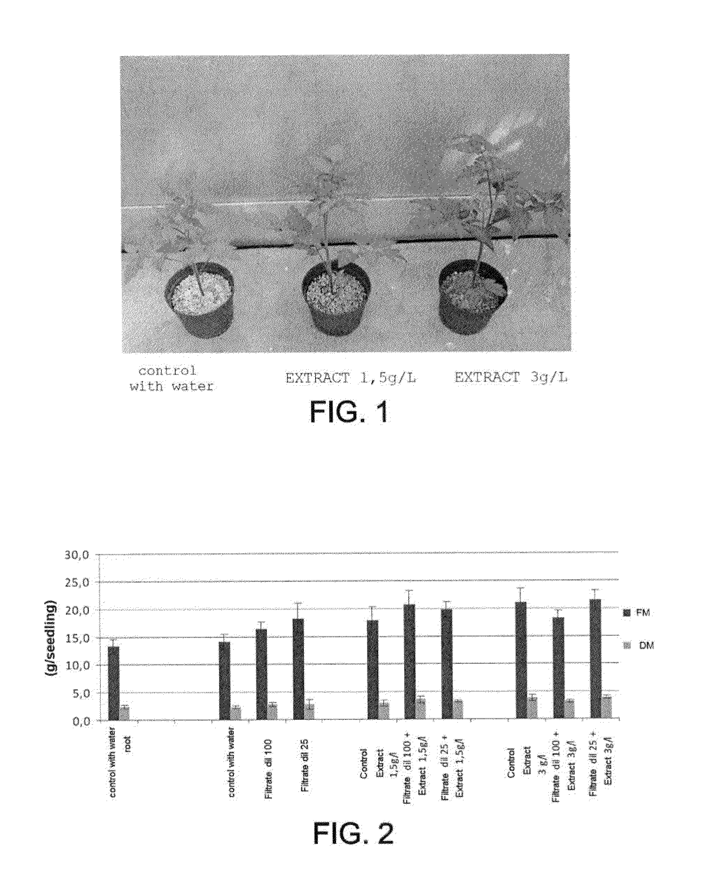

The photograph in FIG. 1 illustrates this aspect of the seedlings for the control, the EXTRACT at 1.5 g/L and 3 g/L.

As summer is a favorable time for growth of the seedlings, they grow more quickly. An improvement in growth of the seedlings following foliar applications of the algal filtrate and of the EXTRACT is observed. Thus, the EXTRACT is very effective for improving the growth of tomato seedlings and no adverse effect occurred during the test. Moreover, those treated with the EXTRACT are remarkable by the red hue of their leaves.

Effect on Weight Increase of the Seedlings

At the end of the experiment, the aerial and root parts are taken, weighed separately (fresh matter, FM), dried for 48 h at 105° C. and weighed again separately (dry matter, DM).

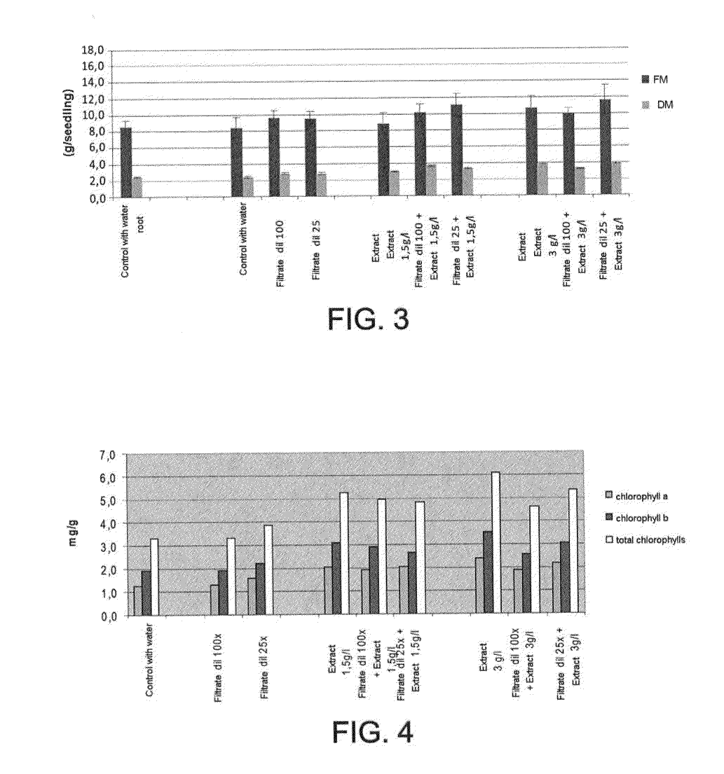

The results presented in the diagrams in FIG. 2 (growth of the aerial parts) and in FIG. 3 (growth of the root parts) show that regardless of the conditions, the growth of the tomato seedlings was promoted relative to the control with water.

As for the results obtained with the EXTRACT, they are unexpected since it is found that when applied alone, it too has an effect on the growth of the tomato seedlings. Its efficacy is equivalent or greater than that of the algal filtrate diluted at 25×, depending on the dose considered.

3—Effect on the Chlorophyll Contents of the Seedlings

The foliar samples are ground in liquid nitrogen and then in phosphate buffer solution, and then chlorophyll a, chlorophyll b and total chlorophylls are determined in acetone at 80% v/v. They are quantified in the spectrophotometer: OD645 nm, OD652 nm and OD663 nm.

The results are presented, in the diagram in FIG. 4.

oust as for growth, a difference between the control with water and the seedlings that received algal filtrate diluted 25 times is observed. Moreover, this increase is even more pronounced for the seedlings that received the EXTRACT.

However, it is preferable to issue a note of caution regarding the high levels of chlorophylls obtained for the groups that received EXTRACT. In fact, as the EXTRACT is red, it colors the leaves. It can therefore be assumed that it will absorb at the absorption wavelengths used for measuring the chlorophylls, thus increasing the measured value.

The results above demonstrate the effect of the EXTRACT on the growth of the tomato seedlings, whether in terms of weight increase or of chlorophyll contents.

### Example 4

The test is similar to that employed in example 3 above. However, the foliar and root applications started at the well-developed 3-leaf stage, and 3 times a week. Root application was stopped after 10 waterings and foliar application after 13 sprayings.

Test: conditions:
Control with water
Algal filtrate diluted 25 times
EXTRACT 0.375 g/L
EXTRACT 0.75 g/L
Algal filtrate diluted 25 times+EXTRACT 0.375 g/L
Algal filtrate diluted 25 times t EXTRACT 0.75 g/L

Results:

1—Effect on the General Appearance of the Seedlings

The seedlings are harvested when differences in terms

of size and color (chlorophyll contents) of the seedlings are clearly visible, i.e. 63 days after sowing. Any other symptom connected with the growing conditions of the seedlings is noted.

The tomato seedlings receiving the algal filtrate or the EXTRACT in foliar application seem larger than the seedlings that received water. However, it is difficult to see a clear difference between the concentrations of EXTRACTS tested.

Moreover, a red coloration is observed on the leaves of tomato seedlings treated with the EXTRACT, although it is less pronounced than in example 3 above.

2—Effect on the Weight Increase of the Seedlings

The aerial and root parts are taken, weighed separately (fresh matter, FM), dried for 48 h at 105° C. and weighed again separately (dry matter, DM).

A control with algal filtrate used in root application was included in the test (results not shown) in order to validate the test. The results proved to be similar to those generally obtained. Thus, the results obtained in foliar application can be analyzed.

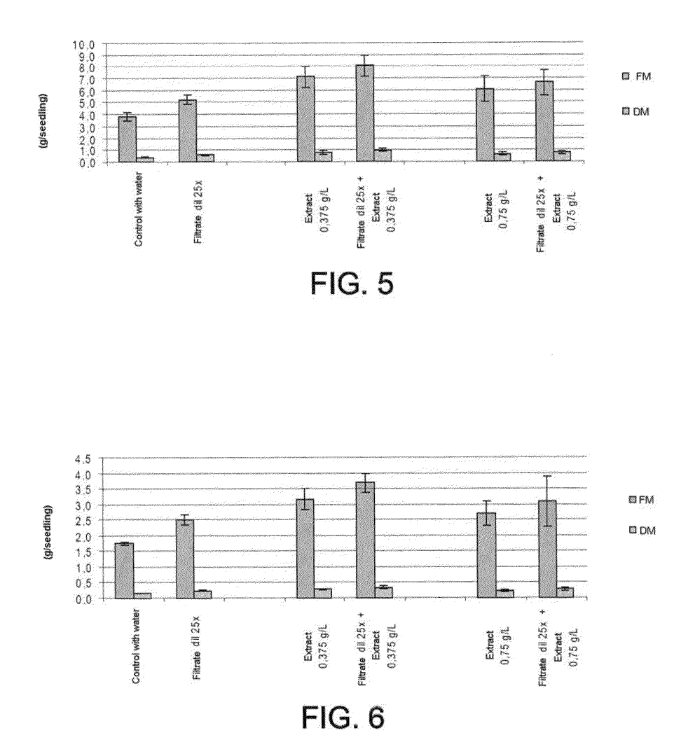

The results presented in the diagrams in FIG. 5 (growth of the aerial parts) and in FIG. 6 (growth of the root parts) show that the algal filtrate alone, in foliar application, slightly improves the weight increase of the tomato seedlings, as observed previously. In the case of the EXTRACT, the results show that, although applied at a reduced, dose, it still has a definite effect on the growth of the seedlings, or even greater than was observed with higher doses.

Furthermore, there is no significant difference between the effect of the EXTRACT applied at a dose of 0.375 g/l and applied at a dose of 0.750 g/l. Moreover, the previous study did not show a significant difference between the 1.5 g/l and 3 g/l doses. It appears that the efficacy of the EXTRACT is similar between these two tests, therefore it is not necessary to use the EXTRACT at high doses.

3—Effect on the Chlorophyll Contents of the Seedlings

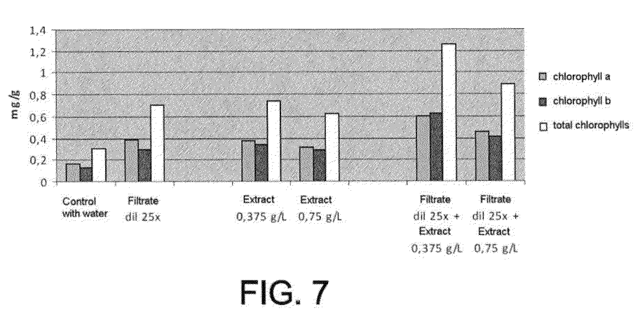

The foliar samples are ground in nitrogen and then in a solution of phosphate buffer and then chlorophyll a, chlorophyll b and total chlorophylls are determined in acetone 80% (v/v). They are quantified in the spectrophotometer, OD645 nm, OD652 nm and OD663 nm. The results are presented in the diagram in FIG. 7.

The algal filtrate and the EXTRACT improve the chlorophyll content in a similar way when they are applied alone. When they are combined, a synergistic effect of the two products on the chlorophyll contents of the seedlings is observed, in contrast to what had been observed for higher doses of EXTRACT,

### CONCLUSION

This example confirms the previous results and demonstrates the action of the EXTRACT on the growth of tomato seedlings, at low dose. In fact, even at doses nearly 10 times lower, the EXTRACT, in foliar application, significantly improves the growth of the deficient tomato seedlings.

1.-7. (canceled)

8. A method of promoting plant growth, which comprises the application of a composition comprising an extract of grape marc on said plants.

9. The method as claimed in claim 8, wherein the composition is an aqueous composition that is applied by foliar spraying or infiltration.

10. The method as claimed in claim 8, wherein the extract comprises more than 45 wt % of polyphenols relative to the dry weight of the extract.

11. The method as claimed in claim 8, wherein the extract comprises more than 70 wt % of polyphenols relative to the dry weight of the extract.

12. The method as claimed in claim 8, wherein the extract comprises more than 0.5 wt % of anthocyans relative to the dry weight of the extract.

13. The method as claimed in claim 8, wherein the extract comprises more than 8 wt % of anthocyans relative to the dry weight of the extract.

14. The method as claimed in claim 8, that wherein the composition further comprises an algal filtrate.

15. A method of increasing chlorophyll content in a plant comprising contacting the plant with an aqueous mixture of a grape marc extract.

16. The method of claim 15, wherein the aqueous mixture further comprises a filtrate from algae.

17. The method of claim 16, wherein the plan is contacted with the aqueous mixture by foliar spraying or by infiltration.
